(19) United States
(12) Patent Application Publication
(10) Pub. No.: US 2012/0293488 A1
(43) Pub. Date: Nov. 22, 2012

(54) STEREO IMAGE CORRECTION SYSTEM AND METHOD

(75) Inventor: Sheng-Chun Niu, Tainan City (TW)

(73) Assignee: HIMAX MEDIA SOLUTIONS, INC., Tainan City (TW)

(21) Appl. No.: 13/110,852

(22) Filed: May 18, 2011

(51) Int. Cl. G06T 15/00

(52) U.S. Cl. 345/419

(57) ABSTRACT

The invention is directed to a stereo image correction system and method. A shift unit vertically shifts one image of a stereo image pair with a shifted amount, and a depth generator generates a depth map of the shifted image pair. A high-pass filter processes the depth map to result in a filtered output, and an analysis unit determines a matching point according to the filtered outputs and the corresponding shifted amounts, wherein the shifted amount at the matching point is determined as a matched shifted amount. A compensation unit vertically shifts the image to be shifted of the stereo image pair with the matched shifted amount.

### BACKGROUND OF THE INVENTION

1. Field of the Invention

The present invention generally relates to stereo imaging, and more particularly to a stereo image correction system and method.

2. Description of Related Art

Three-dimension (3D) imaging is a technique for displaying an image by presenting two images (i.e., a left image and a right image) respectively to the left and right eyes of a viewer. The viewer can perceive 3D depth, with or without wearing 3D glasses, according to disparity between the two images.

However, the two images captured by a 3D imaging system may probably possess a vertical shift between them as exemplified in FIG. 1. The shift may be caused, for example, due to tilting or shaking the 3D imaging system. This shift may incur noise or disturbance in the perceived depth that may degrade the 3D viewing quality or even annoy the viewer.

For the reason that conventional 3D imaging system could incur depth disturbance due to vertical shift between the left image and the right image, a need has arisen to propose a novel scheme to correct or compensate the disturbance.

### SUMMARY OF THE INVENTION

In view of the foregoing, it is an object of the embodiment of the present invention to provide a stereo image correction system and method for compensating a vertical shift between a left image and a right image in a 3D imaging system.

According to one embodiment, a stereo image correction system includes a shift unit, a depth generator, a high-pass filter, an analysis unit and a compensation unit. The shift unit is configured to vertically shift one image to be shifted of a stereo image pair with a shifted amount, while another one image of the stereo image pair is maintained still, thereby resulting in a shifted image pair containing a shifted image and a maintained image. The depth generator is configured to generate a depth map containing depth values on pixels or blocks of the shifted image pair. The high-pass filter is configured to pass frequencies of the depth map above a predetermined, cutoff frequency but attenuate frequencies below the predetermined cutoff frequency, thereby resulting in a filtered output containing high-frequency component of the depth map. The analysis unit is configured to determine a matching point according to a number of the filtered outputs and a number of the corresponding shifted amounts, wherein the shifted amount at the matching point is determined as a matched shifted amount. The compensation unit is configured to vertically shift the image to be shifted of the stereo image pair with the matched shifted amount, thereby resulting in a compensated image pair.

### BRIEF DESCRIPTION OF THE DRAWINGS

FIG. 1 shows an exemplary left (L) image and a right (R) image having a vertical shift therebetween;

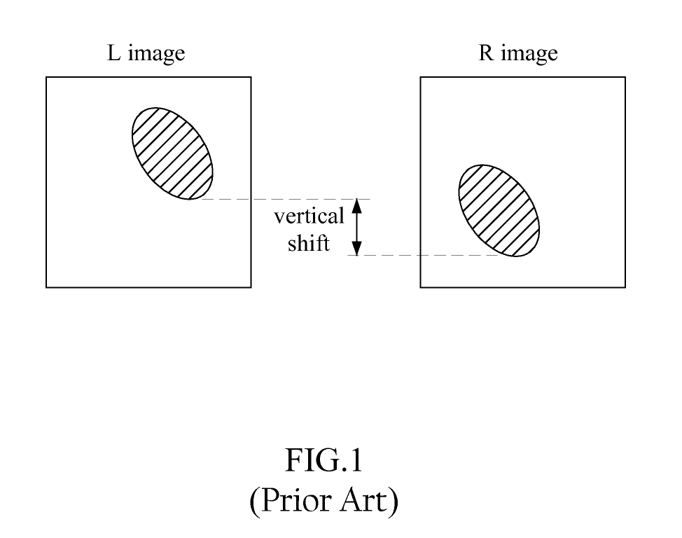

FIG. 2 shows a block diagram illustrative of a stereo image correction system according to one embodiment of the present invention;

FIG. 3 schematically shows a shifted left image (L) and a maintained right image (R); and

FIG. 4 exemplifies recorded high-frequency components and corresponding shifted amounts.

### DETAILED DESCRIPTION OF THE INVENTION

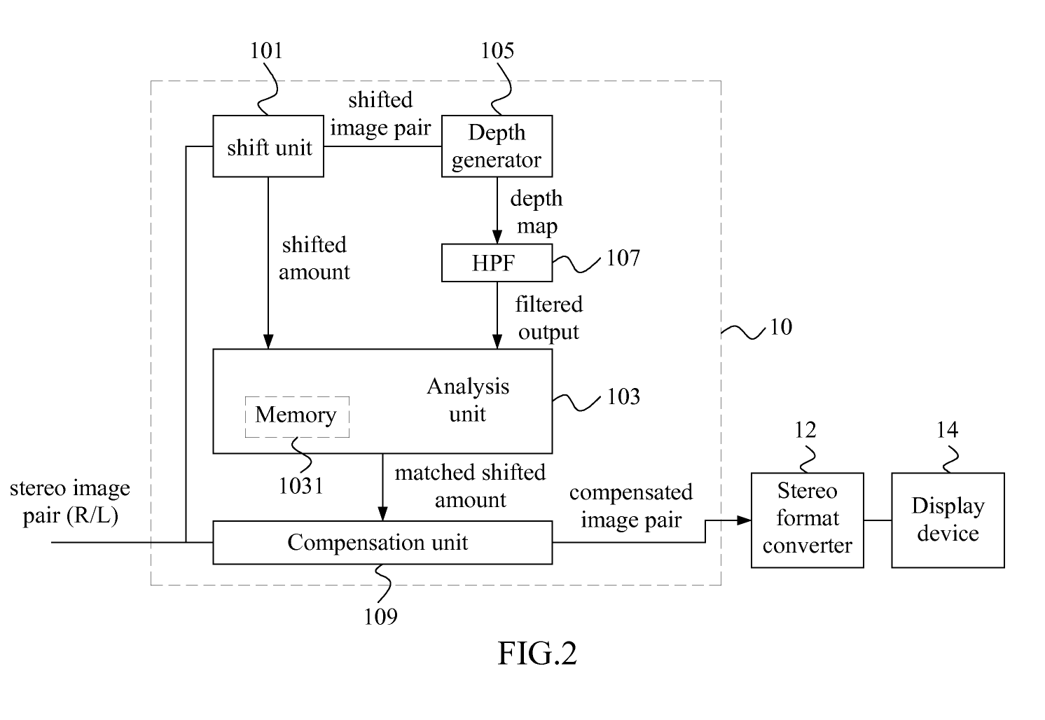

FIG. 2 shows a block diagram illustrative of a stereo (or 3D) image correction, system according to one embodiment of the present invention.

In the embodiment, a stereo image pair comprised of a left image (L) and a right image (R) is received by a stereo image corrector 10. The stereo image pair may be provided, for example, by a 3D image recorder or a 3D image generator. The stereo image pair is subjected to a shift unit 101 that may vertically shift one (e.g., the left image) of the stereo image pair with a shifted amount, while keep the other one (e.g., the right image) of the stereo image pair still. For example, the shift unit 101 shifts (up or down) one or more lines of the left image for every frame or frames. The shifted amount is fed to an analysis unit 103, and is recorded in a memory 1031, which may be internal or external to the analysis unit 103.

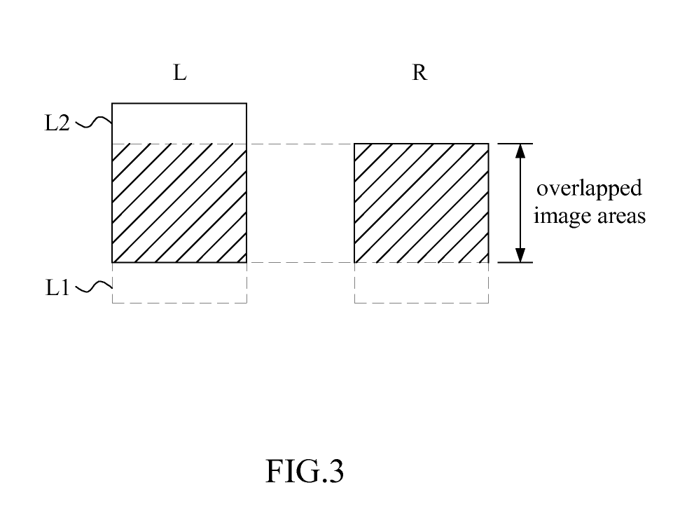

The shifted image pair (i.e., the shifted image and the maintained image) from the shift unit 101 is then fed to a depth generator 105 that generates a depth map containing depth values on pixels or blocks of the shifted image pair. For example, an object near a viewer has a greater depth value than an object far from the viewer. It is noted that the image areas overlapped between the shifted image and the maintained image may be scaled before feeding to the depth generator 105. FIG. 3 schematically shows a left image (L) that is shifted from L1 to L2 while a right image (R) is maintained still. It is observed that the shifted left image L2 has a top portion with blank image. The overlapped image areas (with oblique lines) of the shifted left image L2 and the maintained right image R are scaled up to fill an entire image area, and the scaled images (not shown) are then fed to the depth generator 105.

Subsequently, the depth map is processed by a high-pass filter (HPF) 107 that passes high frequencies of the depth map but attenuates frequencies below a predetermined cutoff frequency. The filtered output containing the high-frequency component of the depth map from the HPF 107 may be utilized to indicate the shifting between the images of the shifted image pair. For example, low filtered output (i.e., low high-frequency noise) indicates that shifted image and the maintained, image of the shifted image pair are better matched. On the other hand, high filtered output (i.e., high high-frequency noise) indicates that shifted image and the maintained image of the shifted image pair are worse matched. The high-frequency component may be generated by counting the amount of frequencies above the predetermined cutoff frequency. Alternatively, the high-frequency component may be generated by accumulating (or integrating) the magnitudes of frequencies above the predetermined cutoff frequency.

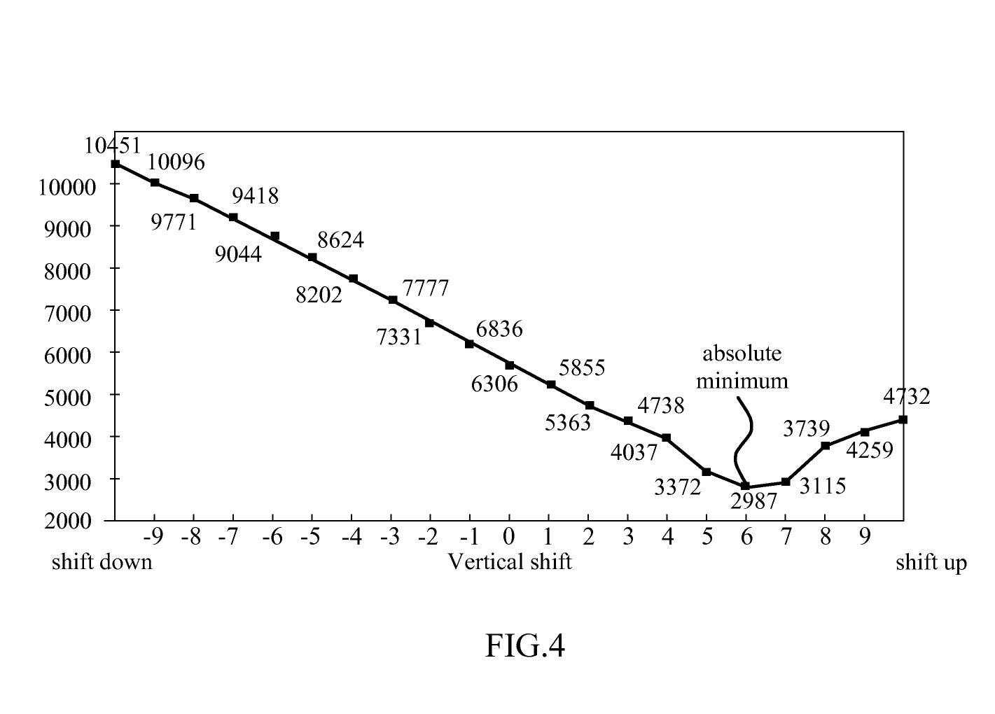

The filtered output is then fed to the analysis unit 103 and recorded in the memory 1031. FIG. 4 exemplifies the recorded high-frequency components (Y-coordinate) and the corresponding shifted amounts (X-coordinate). The analysis unit 103 determines a better (or best) matching point, for example, the absolute minimum point, according to the recorded filtered outputs and the corresponding shifted amounts. The shifted amount at the matching point is determined as the matched shifted amount.

Afterwards, the matched shifted amount is fed to a compensation unit 109 that receives the stereo image pair and then vertically shifts one (e.g., the left image) of the stereo image pair with the matched shifted amount, while keeps the other one (e.g., the right image) of the stereo image pair still. After shifting the image with the matched shifted amount, the shifted image may contain a blank portion. In consideration of this, a technique similar to that as exemplified in FIG. 3 may be utilized such that the overlapped image areas (denoted with oblique lines) of the shifted left image L2 and the maintained right image R are scaled up to fill an entire image area, resulting in a compensated image pair. It is especially noted that, in the embodiment, the stereo image pair is compensated or corrected on a temporal basis, that is, the stereo image pair is compensated while it is displayed. On the contrary, in the conventional technique, an entire 3D video is thoroughly corrected or compensated before the video is ready for display.

The stereo format of the compensated image pair (i.e., the compensated image and the maintained image) may be converted, when required, by a stereo format converter 12. The required stereo format depends on display type of a display device 14, for example, a display device operated with shutter glasses, polarized, glasses or diopter glasses e.g., red-cyan glasses).

Although specific embodiments have been illustrated and described, it will be appreciated by those skilled in the art that various modifications may be made without departing from the scope of the present invention, which is intended to be limited solely by the appended claims.

What is claimed is:

1. A stereo image correction system, comprising:
a shift unit configured to vertically shift one image to be shifted of a stereo image pair with a shifted amount, while another one image of the stereo image pair is maintained still, thereby resulting in a shifted image pair containing a shifted image and a maintained image;
a depth generator configured to generate a depth map containing depth values on pixels or blocks of the shifted image pair;
a high-pass filter configured to pass frequencies of the depth map above a predetermined cutoff frequency but attenuate frequencies below the predetermined cutoff frequency, thereby resulting in a filtered output containing high-frequency component of the depth map;
an analysis unit configured to determine a matching point according to a plurality of the filtered outputs and a plurality of the corresponding shifted amounts, wherein the shifted amount at the matching point is determined as a matched shifted amount; and
a compensation unit configured to vertically shift the image to be shifted of the stereo image pair with the matched shifted amount, thereby resulting in a compensated image pair.

2. The system of claim 1, wherein the stereo image pair is provided by a 3D image recorder or a 3D image generator.

3. The system of claim 1, wherein the shift unit shifts one or more lines of the shifted image for every frame or frames.

4. The system of claim 1, further comprising a memory configured to record the shifted amounts and the corresponding filtered outputs.

5. The system of claim 1, wherein the depth generator generates the depth map according to the shifted image pair that has scaled overlapped image areas between the shifted image and the maintained image.

6. The system of claim 1, wherein the high-frequency component is generated by counting an amount of the frequencies above the predetermined cutoff frequency.

7. The system of claim 1, wherein the high-frequency component is generated by accumulating magnitudes of the frequencies above the predetermined cutoff frequency.

8. The system of claim 1, wherein the matching point is an absolute minimum point at which the filtered output has a minimum value.

9. The system of claim 1, wherein the compensation unit performs on a temporal basis such that the stereo image pair is compensated while it is displayed.

10. The system of claim 1, further comprising:
a display device having a stereo format; and
a stereo format converter configured to convert the compensated image pair into a format complaint with the stereo format of the display device.

11. A stereo image correction method, comprising:
vertically shifting one image to be shifted of a stereo image pair with a shifted amount, while maintaining another one image of the stereo image pair still, thereby resulting in a shifted image pair containing a shifted image and a maintained image;
generating a depth map containing depth values on pixels or blocks of the shifted image pair;
passing frequencies of the depth map above a predetermined cutoff frequency but attenuating frequencies below the predetermined cutoff frequency, thereby resulting in a filtered output containing high-frequency component of the depth map;
determining a matching point, according to a plurality of the filtered outputs and a plurality of the corresponding shifted amounts, wherein the shifted amount at the matching point is determined as a matched shifted amount; and
compensating by vertically shifting the image to be shifted of the stereo image pair with the matched shifted amount, thereby resulting in a compensated image pair.

12. The method of claim 11, wherein the stereo image pair is provided, by a 3D image recorder or a 3D image generator.

13. The method of claim 11, in the step of shifting the stereo image pair to result in the shifted image pair, one or more lines of the shifted image are shifted for every frame or frames.

14. The method of claim 11, further comprising a step of recording the shifted amounts and the corresponding filtered outputs.

15. The method of claim 11, in the step of generating the depth map, the depth map is generated according to the shifted image pair that has scaled overlapped image areas between the shifted image and the maintained image.

16. The method of claim 11, wherein the high-frequency component is generated by counting an amount of the frequencies above the predetermined cutoff frequency.

17. The method of claim 11, wherein the high-frequency component is generated by accumulating magnitudes of the frequencies above the predetermined cutoff frequency.

18. The method of claim 11, wherein the matching point is an absolute minimum point at which the filtered output has a minimum value.

19. The method of claim 11, wherein the compensation step is performed on a temporal basis such that the stereo image pair is compensated while it is displayed.

20. The method of claim 11, further comprising a step of converting the compensated image pair into a format complaint with the stereo format of a display device.
